(19) United States
(12) Patent Application Publication
(10) Pub. No.: US 2004/0235537 A1
(43) Pub. Date: Nov. 25, 2004

(54) Radio communications apparatus

(75) Inventors: Tetsuji Koga, Oonojou-shi (JP); Kenichi Shibata, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/847,295

(22) Filed: May 18, 2004

(30) Foreign Application Priority Data
May 19, 2003 (JP) 2003-140155
May 22, 2003 (JP) 2003-144473

(51) Int. Cl. H04Q 7/20; H04M 1/00

(52) U.S. Cl. 455/574; 455/572; 455/421

(57) ABSTRACT

The invention reduces the power consumption of a handset in the no service area and automatically returns the handset to regular operation in case the radio communications apparatus is being recharged, thereby preventing the handset from being left inactive. The inventive handset comprises a no service area detector which detects that the handset has moved outside the coverage of the base unit, and automatically makes a transition to the power saving mode where the base unit is not searched for in case the handset has moved outside the coverage of the base unit. When it is determined that the handset is being recharged in the power saving mode, the handset switches to the regular mode. In case the handset is powered off when the charging determination unit has determined that charging is under way, the handset automatically performs power-on processing.

### BACKGROUND OF THE INVENTION

The present invention relates to radio communications apparatus such as the handset of cordless radio communications apparatus and a cell phone.

A radio wave in the 2.4 GHz band (2.400 GHz-2.483 GHz) is used for a variety of devices including ham radio equipment, a microwave oven and various types of medical instruments. Thus, when a radio wave in the 2.4 GHz band is used for radio communication apparatus, the Frequency Hopping (FH) system as a communications system employing the Spread Spectrum (SS) is utilized. For example, on a page located at URL: http://www.panasonic.com/consumer electronics/telephones/multitalk phones.asp#24 which can be browsed on the Internet is introduced a cordless telephone set which uses the 2.5 GHz Frequency-Hopping Spread Spectrum (FHSS) Technology (this site can be browsed as of Apr. 17, 2003).

The frequency hopping system switches over the frequency of a carrier wave in use (performs hopping) at a predetermined extremely short period (typically around 10 ms) to perform communications. In the frequency hopping system, the transmitting frequencies are changed one after another so that noise occurring in a specific frequency can be corrected by using data communicated on another frequency. Further, it is possible to select a frequency with little noise to perform data transmissions.

Radio communications apparatus which uses the frequency hopping system performs so-called an open search: the radio communications apparatus (handset) searches for its base unit for location registration when the handset has moved out of the coverage of the base unit, that is, when the handset is in no service area.

While the handset remains unlinked with the base unit for a prolonged period because of the base unit being turned off, the handset keeps searching for the base unit almost endlessly. A search in the frequency hoping system is made on the split frequencies so that placing the handset in the open search state continually consumes the battery power of the handset, which has serious effects on the available service hour of the handset.

Radio communications apparatus conforming to PDC (Personal Digital Cellular) system or PHS (Personal Handyphone System) also searches for its base unit to perform location registration while it is in no service area. Prolonged failure to search for the base unit presents a problem of battery consumption. As a technology to solve the problem, for example, the Japanese Patent Laid-Open No. 2000-69552 describes a technology to reduce the power consumption of a battery by gradually extending the search period of the handset while it is in no service area.

While such a technology is effective for PDC-based and PHS-based radio communications apparatus, it is no longer effective for a case where the search time in a single open search is approximately 11 seconds such as operation of radio communications apparatus of the frequency hopping system. Power consumption in the open search state is still large even when the search period of the base unit is extended, so that it is impossible to effectively reduce the power consumption.

While the battery depletion is prevented when the user turns off the apparatus each time he/she enters no service area. This approach has a drawback: the user must manually turn off the apparatus when he/she enters no service area, which is cumbersome. Another problem is that, when the user forgets to turn on the power, the handset stays inactive.

### SUMMARY OF THE INVENTIONI

In view of the aforementioned problems, the invention aims at providing radio communications apparatus which suppresses power consumption in no service area by limiting the operation of search for a base unit in case a handset has moved outside the coverage. The invention also aims at preventing the handset operation from being halted by automatically placing the handset in normal operating state as long as the handset is being recharged.

In order to solve the problems, radio communications apparatus according to the invention comprises a no service area detector which detects that the radio communications apparatus is out of a coverage of a base unit and the radio communications apparatus automatically enters a power saving mode where a search for the base unit is not performed in case the radio communications apparatus has moved outside the coverage of the base unit. This reduces power consumption.

The radio communications apparatus switches to an ordinary mode when the radio communications apparatus has detected that it is being recharged while in the power saving mode. When charge determination means has detected that the radio communications apparatus is being recharged, radio communications apparatus performs power on processing. By doing so, the radio communications apparatus automatically returns to ordinary operation on start of charging instead of being left inactive.

### BRIEF DESCRIPTION OF THE DRAWINGS

FIG. 1 is a block diagram of radio communications apparatus according to an embodiment of the invention;

FIG. 2 a flowchart showing the flow of communications of the radio communications apparatus in FIG. 1 with a base unit;

FIG. 3 is a block diagram showing the configuration of cordless radio communications apparatus as a second embodiment of the radio communications apparatus according to the invention;

FIG. 4 is a functional block diagram showing the controller of a handset of the cordless radio communications apparatus shown in FIG. 3; and

FIG. 5 is a flowchart showing the operation of the handset of the cordless radio communications apparatus shown in FIG. 3.

### DETAILED DESCRIPTION OF THE PREFERRED EMBODIMENTS

(Embodiment 1)

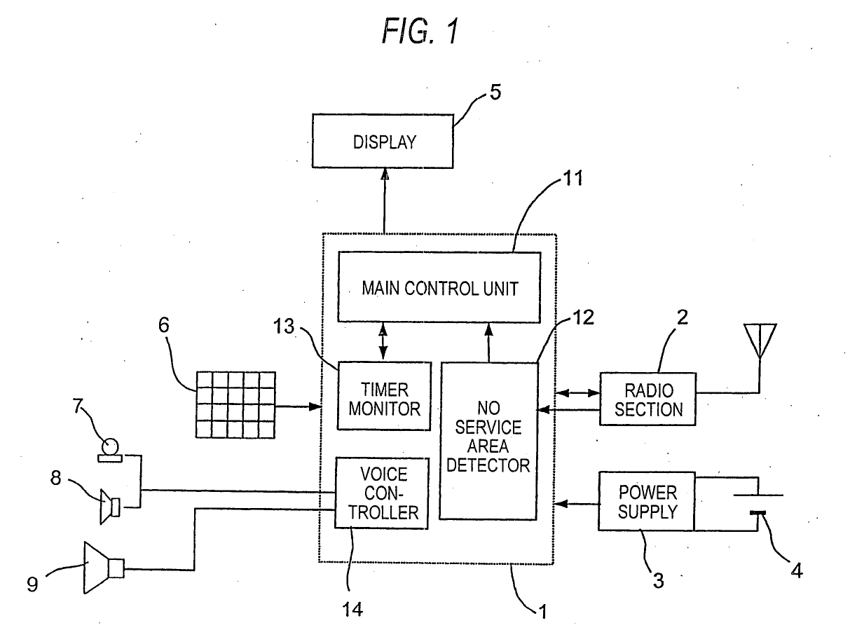

Embodiments of the invention are described below referring to the drawings. FIG. 1 is a block diagram of radio communications apparatus according to an embodiment of the invention;

The radio communications apparatus according to the embodiment is a handset which communicates with a base unit (not shown) by using a radio wave in the 2.4 GHz band in accordance with the frequency hopping system. Referring to FIG. 1, the radio communications apparatus comprises a controller 1 which controls each section, a radio section 2 which includes a transmitter circuit and a receiver circuit, a power supply 3 including a power supply circuit, and a battery 4 as a power supply for feeding power to the power supply 3.

The radio communications apparatus shown in FIG. 1 comprises a display 5 which displays various information such as the information that the radio communications apparatus is in/out of the coverage, receiving field density, calling/called number, and residual battery power, an operation panel 6 which comprises dial keys for performing operations such as input of dial information and call origination/termination as well as a talk key, a transmitter 7, a receiver 8 and a loudspeaker 9.

The controller 1 comprises a main control circuit 11 whose center includes a microcomputer, and a memory (not shown). The controller 1 also comprises a no service area detector 12 which detects that the radio communications apparatus has moved outside the coverage of the base unit, that is, in no service area, a timer monitor 13 which monitors the elapse of a predetermined time, and a voice controller 14 which controls the transmitter 7, the receiver 8, and the loudspeaker 9.

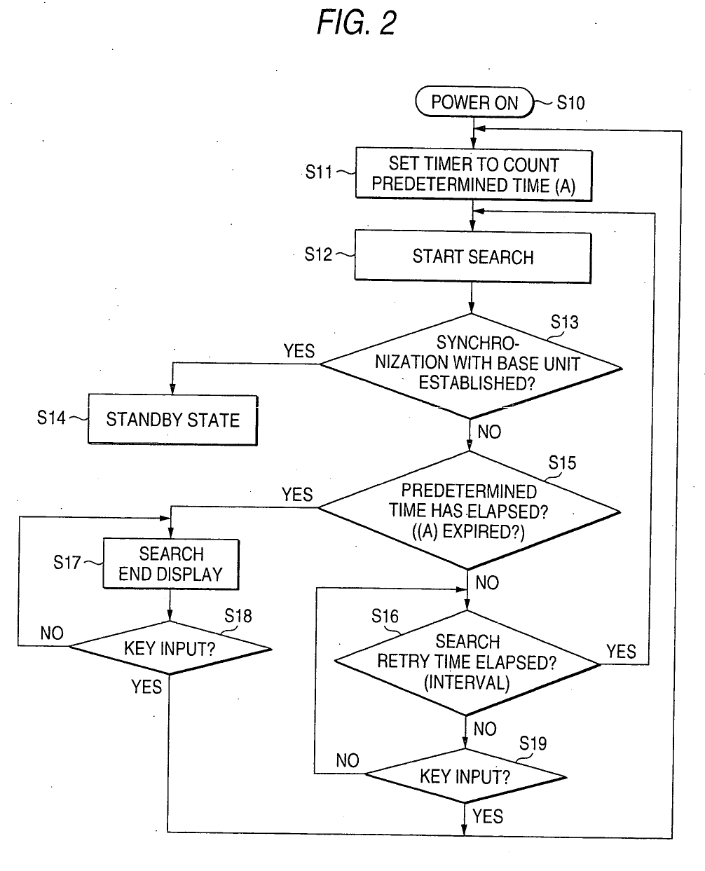

The radio communications apparatus of this configuration communicates with the base unit as described below. FIG. 2 is a flowchart showing the flow of communications of the radio communications apparatus in FIG. 1 with the base unit.

In step S10, the main control circuit 11 is turned on (powered on). In step S11, the main control circuit 11 sets the predetermined time monitored by the timer monitor 13. Since synchronization with the base unit is not established when the radio communications apparatus is powered on (a state where the result of detection by the no service area detector 12 is “no service area”), in step S12, the main control circuit 11 starts a search for the base unit. When synchronization of the radio communications apparatus with the base unit is established in step S13, the main control circuit 11 is placed in the standby state (step S14).

In case synchronization with the base unit is not established in step S13, the main control circuit 11 monitors whether the predetermined time has elapsed on the timer monitor 13 in step S134. In other words, the processing of steps S13, S15, S16, S21 and S13 is repeated for a while until the predetermined time has elapsed after power-on.

In case the predetermined time has elapsed without synchronization with the base unit being established in step S15, the main control circuit 11 determines that the “no service area” state has continues for the predetermined and displays “search end” on the display 5 as well as cancels the search for the base unit then switches to the power saving mode in step S17. In the figure, the processing loop is step S17, step S18 and step S17 again. The main control circuit 11 continues displaying “search end” on the display 5 until a key input is made from the operation panel in step S18.

As required, for example when the user makes a key input from the operation panel 6 in order to originate a call (step S18), the main control circuit 11 which has detected the key input performs the processing of step S11 and returns to the base unit search state from the power saving mode. In this way, a search for the base unit is arbitrarily resumed by using the occurrence of predetermined processing as a trigger, thereby entering the communicable state.

When a key input is made from the operation panel 6 in step S18, the main control circuit 11 returns to the processing of step S1, where the main control circuit 11 sets the predetermined time on the timer monitor 13, and starts a search for the base unit in step S12. The base unit search state is processed in a loop including steps S12, S13, S15, (S16, S19) and S12. In case the base unit search state continues without synchronization with the base unit being established, search operation is performed in predetermined intervals. Step S16 is provided to maintain the search operation repeating interval. In step S16, the main control circuit 11 monitors the elapse of the search retry time to adjust the interval up to start of the next search. When a key input is made from the operation panel 6 in step S19, the main control circuit 11 returns to the processing of step S11 without waiting for the search retry time to elapse. In step S11, the main control circuit 11 sets the predetermined time on the timer monitor 13, and starts a search for the base unit in step S12.

In this way, the radio communications apparatus according to this embodiment detects that the radio communications apparatus has moved outside the coverage of the base unit and switches to the power saving mode in case the “no service area” state has continued for a predetermined time to cancel the base unit search. This reduces power consumption of the battery 4 required for a base unit search when the radio communications apparatus is out of the coverage.

While the radio communications apparatus switches to the power saving mode in case the “no service area” state has continued for a predetermined time to cancel the base unit search in this embodiment, a configuration is allowed where the radio communications apparatus switches to the power saving mode in case the user has performed predetermined operation for mode switching.

While a key input from the operation panel 6 is employed as a trigger to restart the search for the base unit in this embodiment, start of charging of the battery 4 may be used as a trigger to restart the search for the base unit. A signal picked up from a charging cradle (not shown) used to recharge the battery 4 in the handset when the radio communications apparatus is placed in the charging cradle may be used as a trigger. In this case, power consumption is no longer a problem because charging of the battery 4 has started. Thus it is possible to restart the base unit search and place the radio communications apparatus in the communicable state.

(Embodiment 2)

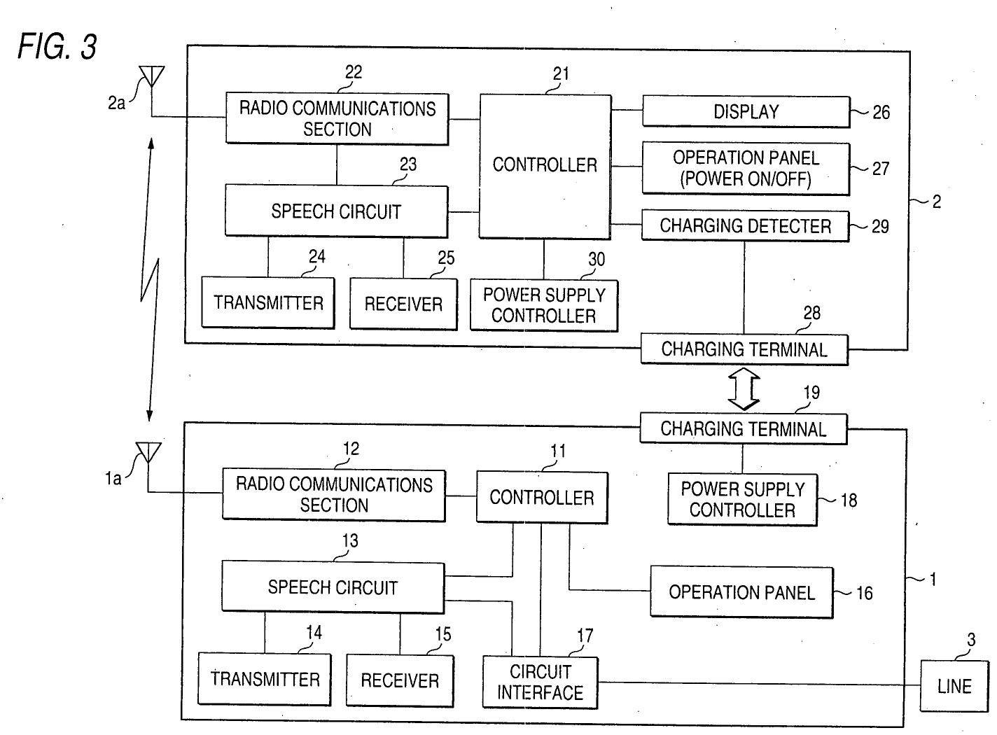

FIG. 3 shows radio communications apparatus according to Embodiment 2 of the invention.

Referring to FIG. 3, a numeral 1 represents a base unit, 2 a handset capable of communicating with the base unit 1 via an antenna 1a of the base unit 1 and an antenna 2a of the handset.

The base unit 1 comprises a controller 11 which controls the entire system, a radio communications section 12 which performs radio communications with the handset 2, a speech circuit 13 to which a transmitter 14 and a receiver 15 are connected, an operation panel 6, and a circuit interface 17 for communications with a telephone line 3. The base unit 1 comprises a charging terminal 19 connected to a charging terminal 28 (mentioned later) of the handset 2, and a power supply controller 18 which feeds a charging current to the handset 2 as well as feeds power to each section of the base unit.

The handset 2 comprises a controller 21 which controls the entire system, a radio communications section 22 which performs radio communications with the base unit 1, a speech circuit 23 to which a transmitter 24 and a receiver 25 are connected, a display 26 which displays characters and data, an operation panel 27 which performs operation such as power on/off, a charging terminal 28 connected to the charging terminal 19 of the base unit 1, a charging detector which detects presence of a charging current from the charging terminal 28, and a power supply controller which houses a battery (not shown) and feeds power to the handset 2.

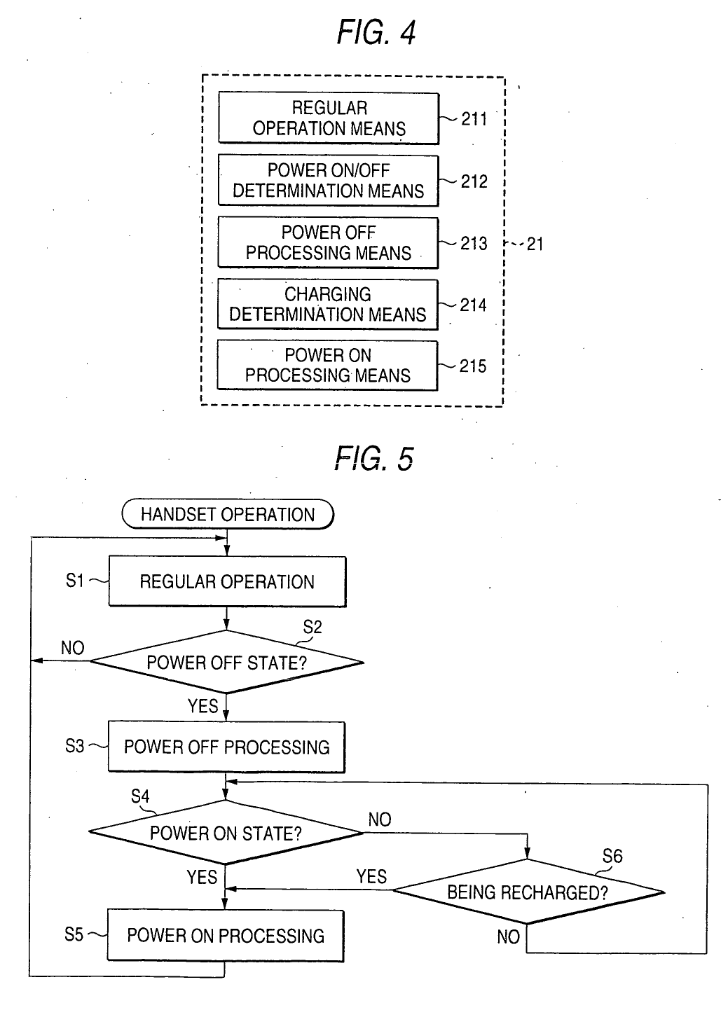

FIG. 4 is a functional block diagram showing the controller 10′ 21 of the handset 2 in FIG. 3. Each function is implemented by way of software. As shown in FIG. 4, the controller 21 of the handset 2 comprises regular operation means 211 which performs ordinary operation when the operation panel 27 is in powered on state, power on/off determination means 212 which determines whether the operation panel 27 is turned off in the ordinary operation and which determines whether the operation panel 27 is turned on when power off processing is performed by power off processing means 213 mentioned later, power off processing means 213 which performs power off processing when the power on/off determination means 212 has determined that the operation panel 27 is turned off, charging determination means 214 which determines whether the handset 2 is being recharged based on the detection result of charging detector 29 when the power on/off determination means 212 has determined that the operation panel 27 is not turned on, and power on processing means 215 which performs power on processing when the power on/off determination means 212 has determined that the operation panel 27 is turned on or when the charging determination means 214 has determined that the handset 2 is being recharged.

Operation of thus configured controller 21 of the handset 2 is described referring to FIG. 5. FIG. 5 is a flowchart showing the operation of the controller 21 of the handset 2 shown in FIG. 3. It is assumed that the operation panel 27 is initially powered on state.

Referring to FIG. 5, the regular operation means 211 performs ordinary operation on checking that the operation panel 27 is powered on state (step S1).

In the regular operation, the power on/off determination means 212 determines whether the operation panel 27 is turned off (whether it has entered the power off state from the power on state) in step S2. In case the power on/off determination means 212 has determined that the operation panel 27 is not powered off in step S2, execution returns to step S1. In case the power on/off determination means 212 has determined that the operation panel 27 is powered off in step S2, the power off processing means 213 performs power off processing (step S3).

On completion of power off processing, the power on/off determination means 212 determines whether the operation panel 27 is turned on (whether it has entered the power on state from the power off state) in step S4. In case the power on/off determination means 212 has determined that the operation panel 27 is powered on, the power on processing means 215 performs power on processing (step S5).

In case the power on/off determination means 212 has determined that the operation panel 27 is not in powered on state in step S4, the charging determination means 214 determines whether the handset 2 is being recharged based on the detection result of charging detector 29 (step S6). In case the charging determination means 214 has determined that the handset 2 is not being recharged in step 6, execution returns to step S4. That is, in case the handset 2 is not being recharged, the handset 2 is placed in the standby state for turning on. In case the charging determination means 214 has determined that the handset 2 is being recharged in step 6, the power on processing means 215 performs power on processing (step S5).

As mentioned above, according to this embodiment, the controller 21 comprises power on/off determination means 212 which determines whether the operation panel 27 is powered on, charging determination means 214 which determines whether the handset 2 is being recharged based on the detection result of charging detector 29 when the power on/off determination means 212 has determined that the operation panel 27 is powered off, and power on processing means 215 which performs power on processing when the power on/off determination means 212 has determined that the operation panel 27 is powered on or when the charging determination means 214 has determined that the handset 2 is being recharged. As a result, it is possible to perform power on processing such as turning on the power supply and making a transition to regular processing when the power on/off determination means 212 has determined that the operation panel 27 is powered on (it has entered the power on state) while the power off processing is under way. It is also possible to automatically execute the power on processing or manually place the operation panel 27 in the power on state when it is determined that the handset 2 is being recharged while the power off processing is under way. It is also possible to automatically make a transition from the power off state to the power on state while the handset 2 is being recharged.

While charging of the handset 2 is made by way of a charging current from the base unit 1 in FIG. 3, charging of the handset 2 by using a separate power supply for the handset is well within the scope of the invention and provides the same advantage.

The radio communications apparatus is a handset 2 of the cordless radio communications apparatus comprising the base unit 1 and the handset 2. The handset 2 of the cordless radio communications apparatus may be manually placed in the power on state or may automatically make a transition from the power off state to the power on state in case the handset 2 is being recharged.

While the handset 2 of the cordless radio communications apparatus is shown as radio communications apparatus in this embodiment, for example a portable telephone such as a PHS phone and a car phone may be used as radio communications apparatus in this invention. In this case also, the radio communications apparatus may be manually placed in the power on state or may automatically make a transition from the power off state to the power on state in case it is being recharged.

The present disclosure relates to subject matter contained in priority Japanese Patent Application Nos.P2003-140155 filed on May 19, 2003 and P2003-144473 filed on May 22, 2003, the contents of which are herein expressly incorporated by reference in its entirety.

What is claimed is:

1. A radio communications apparatus comprising:
a) an operation panel on which the user instructs start of operation;
b) a no service area detector which detects that the radio communications apparatus has moved outside the coverage of a base unit; and
c) a controller which controls the entire system;
wherein said controller
d) makes a transition to a power saving mode where said base unit is not searched for in case it is determined that the state where the radio communications apparatus is off the coverage of said base unit for a predetermined time as a result of detection by the no service area detector, and
e) returns to the base unit search state by using the occurrence of predetermined processing as a trigger and controls each section so as to restart base unit search.

2. The radio communications apparatus according to claim 1, wherein said predetermined processing as a trigger is start of charging.

3. A radio communications apparatus comprising:
a) a charging detector which detects whether the radio communications apparatus is being recharged;
b) an operation panel on which the user instructs start of operation;
c) a battery which serves as a power supply; and
d) a controller which controls the entire system;
said controller including:
e) mode switching means which switches, by way of the user's operation, from the base unit search state to the power saving mode where a search for the base unit is canceled; and
f) charging determination means which determines whether the radio communications apparatus is being recharged in the power saving mode based on the detection result of said charging detector;
wherein said controller
g) switches to a regular mode on determining whether said charging determination means has determined that the radio communications apparatus is being recharged in the power saving mode.

4. A radio communications apparatus comprising:
a) a charging detector which detects whether the radio communications apparatus is being recharged;
b) an operation panel on which the user instructs start of operation; and
c) a controller which controls the entire system;
said controller including:
d) power supply control means which switches between the power on state and the power off state based on the operation of the user; and
e) charging determination means which determines whether the radio communications apparatus is being recharged in the power off state based on the detection result of said charging detector;
wherein said controller
f) switches to the power on state by using the start of charging detected by said charging determination means as a trigger.

5. The radio communications apparatus according to claim 4, wherein said radio communications apparatus is the handset of cordless radio communications apparatus comprising a base unit and a handset.

6. The radio communications apparatus according to claim 4, wherein said radio communications apparatus is a portable telephone which performs radio communications with a public base station.

7. A radio communications apparatus comprising a base unit and a handset, said handset including:
a) a battery which serves as a power supply for the handset;
b) a transmitter and a receiver for voice calls;
c) an operation panel on which the user instructs start of operation;
d) a no service area detector which detects that the handset has moved outside the coverage of the base unit; and
e) a controller; wherein said controller
f) makes a transition to a power saving mode where said base unit search is canceled in case it is determined that the state where the handset is off the coverage of said base unit for a predetermined time as a result of detection by the no service area detector and
g) returns to the base unit search state and controls each section so as to restart operation in case predetermined operation is performed on said operation panel or in case the handset is connected to the power supply for charging the handset and charging is started.

8. A radio communications apparatus comprising a base unit which includes a base unit radio section for performing communications with a handset by radio waves and a handset which includes a handset radio section for performing communications with said base unit by radio waves; said handset including:
a) a battery which serves as a power supply for the handset;
b) a transmitter and a receiver for voice calls;
c) an operation panel on which the user instructs start of operation;
d) a no service area detector which detects that the handset has moved outside the coverage of the base unit; and
e) a handset controller;
wherein said base unit comprises
f) a charging circuit for charging said battery;
wherein said handset controller
g) makes a transition to a power saving mode where said base unit search is canceled in case it is determined that the state where the handset is off the coverage of said base unit for a predetermined time as a result of detection by the no service area detector and
h) returns to the base unit search state and controls each section so as to restart operation in case predetermined operation is performed on said operation panel or in case charging of the battery by said charging circuit is started.

9. The radio communications apparatus according to claim 8, wherein said base unit radio section and said handset radio section communicates with each other by way of frequency hopping.

10. A radio communications apparatus comprising abase unit which includes a base unit radio section for performing communications with a handset by radio waves and a handset which includes a handset radio section for performing communications with said base unit by radio waves, both radio sections are radio communications apparatus performing radio communications by way of frequency hopping; said handset including:
a) an operation panel on which the user instructs start of operation;
b) a no service area detector which detects that the handset has moved outside the coverage of the base unit; and
c) a controller; wherein said controller
d) makes a transition to a power saving mode where said base unit search is canceled in case it is determined that the state where the handset is off the coverage of said base unit for a predetermined time as a result of detection by the no service area detector and
e) returns to the base unit search state by using a predetermined key input on said operation panel as a trigger and controls each section so as to restart base unit search.

11. A radio communications apparatus comprising:
a) a charging detector which detects whether the radio communications apparatus is being recharged;
b) an operation panel on which the user instructs start of operation;
c) a battery which serves as a power supply; and
d) a controller which controls the entire system; said controller including:
e) power on/off determination means which determines whether the radio communications apparatus is in the power on state;
f) charging determination means which determines whether the radio communications apparatus is being recharged based on the detection result of said charging detector when said power on/off determination means has determined that the radio communications apparatus is not in the power on state; and
g) power on processing means which performs power on processing when said power on/off determination means has determined that the operation on said operation panel instructs power on, or when said charging determination means has determined that the radio communications apparatus is being recharged in case the radio communications apparatus is not in the power on state.
